(19) United States
(12) Patent Application Publication
(10) Pub. No.: US 2005/0045559 A1
(43) Pub. Date: Mar. 3, 2005

(54) Compositions and methods for separating constituents

(76) Inventors: Quinjie Wang, Hockessin, DE (US); James D. Martosella, Downingtown, PA (US); Brian A. Bidlingmeyer, Frazer, PA (US)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 10/651,637

(22) Filed: Aug. 29, 2003

(51) Int. Cl. B01D 15/08

(52) U.S. Cl. 210/656; 210/198.2

(57) ABSTRACT

Compositions include stationary phases that include at least one bonded phase, where the bonded phase includes a silicon atom directly attached to (1) at least one bulky group, and (2) a long chain with an embedded polar group where in certain embodiments the embedded polar group is carbonate, carbamate, urea, ether, or amide. In certain embodiments, the bulky group is an alkyl or an aryl such as isopropyl or isobutyl. The compositions may be contacted with a mobile phase under conditions sufficient to separate the at least two constituents. Also provided are systems and kits for use with the subject methods.

### FIELD OF THE INVENTION

The field of this invention is chromatography, and more specifically high performance liquid chromatography.

### BACKGROUND OF THE INVENTION

The goal of many chemical analysis protocols is to separate a sample (blood, tears, urine, water from a well, etc.) into its individual components or constituents so that each component may be evaluated without any interference from other components. One technique that is often employed to separate various constituents of a sample from each other is chromatography, where liquid chromatography (“LC”) is often employed. Liquid chromatography is an analytical chromatographic technique that is useful for separating ions or molecules that are dissolved in a liquid or solvent. If the sample solution is in contact with a second solid or liquid phase, the different solutes will interact with the other phase to differing degrees due to differences in adsorption, ion-exchange, partitioning, or size. These differences allow the mixture components to be separated from each other by using these differences to determine the transit time of the solutes through a column. Chromatography may be coupled with a suitable detection system that can characterize each type of separated constituent. One liquid chromatography protocol that is often employed due to its versatility is high performance liquid chromatography (“HPLC”).

Generally, HPLC includes passing a sample of constituents in a high pressure fluid or solvent (called the mobile phase) through a tube or column. The column is packed with a stationary phase. The stationary phase typically includes particles such as porous beads or the like. The pore sizes can be varied to allow certain sized analytes to pass through at different rates. As the constituents pass through the column they interact with the mobile and stationary phases at different rates. The difference in rates is due to the difference in one or more physical properties of the constituents, e.g., different polarities. The constituents that have the least amount of interaction with the stationary phase, or the most amount of interaction with the mobile phase, will thus exit the column faster.

As the various constituents exit the column, they can be detected by various techniques, e.g., refractive index, electrochemical, or ultraviolet-absorbance changes in the mobile phase, which can indicate the presence of a constituent. The amount of constituent exiting the column may be determined by the intensity of the signal produced in a detector. A detector is employed to measure a signal peak as each constituent exits the column. By comparing the time it takes for the peak to show up (also referred to as the retention time) with the retention times for a mixture of known compounds, the constituents of unknown sample mixtures can be identified. By measuring the signal intensity (also referred to as the response) and comparing it to the response of a known amount of that particular analyte, the amount of analyte in the mixture can be determined.

One particularly useful mode of HPLC—particularly for the separation of highly polar or ionizable constituents, is reversed phase high performance liquid chromatography (“RP-HPLC”). RP-HPLC primarily operates on the basis of hydrophilicity and lipophilicity to separate various constituents of a liquid medium from each other. The stationary phase includes a bonded phase that may be hydrophobic, e.g., alkyl chains, that facilitate the separation of the constituents. For example, the greater the hydrophobicity of the bonded phase, the greater is the tendency of the hydrophobic constituents in the mobile phase to be retained in the column while the hydrophilic constituents are eluted more rapidly from the column than the hydrophobic constituents. However, one problem that often occurs with such separation protocols is the hydrolysis of the bonded phase by the mobile phase, especially if the mobile phase has a low to medium pH.

While attempts have been made to optimize these separation protocols, e.g., to improve and/or differentiate selectivity over conventional bonded phases such as alkyl bonded phases such as C8 and C18 bonded phases, and to improve retention and peak shape of acidic and basic analytes by incorporating polar functional groups into the bonded phase, none have met with complete success. For example, conventional bonded phases having polar functional groups have not solved the problem of hydrolysis of the bonded phase by the mobile phase.

Accordingly, there continues to be an interest in the development of new compositions and methods for separating constituents. Of particular interest is the development of compositions, systems and methods for separating constituents that may have good: resistance to hydrolysis, selectivity, retention of constituents, peak shape, ease of use and or cost effectiveness.

REFERENCES OF INTEREST INCLUDE: U.S. Pat. Nos. 5,374,755; 4,847,159 and 4,705,725. Also of interest is Feibush, et al., Journal of Chromatography; 544, 41 (1991).

### SUMMARY OF THE INVENTION

Compositions include stationary phases that include at least one bonded phase, where the bonded phase includes a silicon atom directly attached to (1) at least one bulky group, and (2) a long chain with an embedded polar group where in certain embodiments the embedded polar group is carbonate, carbamate, urea, ether, or amide. In certain embodiments, the bulky group is an alkyl or an aryl such as isopropyl or isobutyl. The compositions may be contacted with a mobile phase under conditions sufficient to separate the at least two constituents. Also provided are systems and kits for use with the subject methods.

### BRIEF DESCRIPTIONS OF THE DRAWINGS

FIG. 1 shows a generalized, schematic illustration of a representative embodiment of the subject stationary phases.

FIG. 2 shows a representative embodiment of the subject stationary phases.

FIG. 3 shows an exemplary embodiment of a subject system for separating at least two constituents using the stationary phases of the subject invention.

### DETAILED DESCRIPTION OF EMBODIMENTS OF THE INVENTION

Compositions include stationary phases that include at least one bonded phase, where the bonded phase includes a silicon atom directly attached to (1) at least one bulky group, and (2) a long chain with an embedded polar group where in certain embodiments the embedded polar group is carbonate, carbamate, urea, ether, or amide. In certain embodiments, the bulky group is an alkyl or an aryl such as isopropyl or isobutyl. The compositions may be contacted with a mobile phase under conditions sufficient to separate the at least two constituents. Also provided are systems and kits for use with the subject methods.

Before the present invention is described, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described. All publications mentioned herein are incorporated herein by reference to disclose and describe the methods and/or materials in connection with which the publications are cited.

It must be noted that as used herein and in the appended claims, the singular forms “a”, “an”, and “the” include plural referents unless the context clearly dictates otherwise.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention.

The figures shown herein are not necessarily drawn to scale, with some components and features being exaggerated for clarity.

In further describing the subject invention, embodiments of the subject compositions are first described in greater detail, followed by a description of systems that employ the subject compositions. Next, a description of the subject methods is described. Finally, kits for use in practicing the subject methods are described.

Compositions

As mentioned, embodiments of the subject compositions are employed to separate at least two constituents in a mobile phase. In general, the subject compositions are stationary phases that include a substrate and at least one bonded phase attached to the substrate. The bonded phase includes a silicon atom directly attached to (1) at least one bulky group, and (2) a long chain having an embedded polar group. By “polar group” is meant a chemical group having an uneven distribution of electrons such that one part of the group has a positive charge and another part has a negative charge. By “embedded” is meant a chemical group which is positioned within the backbone of the long chain. For example, as described in greater detail below, two bulky groups may be directly attached to the silicon atom at different positions. The embedded polar group may be any suitable polar group, where in many embodiments the embedded polar group is carbonate, carbamate, urea, ether or amide. The silicon atoms of the bonded phase can be attached to free functional groups, e.g., hydroxy groups, present on the surface of a substrate, e.g., typically bonded to an oxygen atom of the substrate. The subject stationary phases advantageously enable separation of at least two constituents present in a mobile phase while resisting hydrolysis of the bonded phase by the mobile phase and provide different and alternative selectivity from conventional bonded phases such as C18 and C8 bonded phases. Certain embodiments may provide good: retention of constituents and peak shape of acidic and basic constituents over conventional separation protocols, as well as other advantages that will be apparent to those of skill in the art upon reading this disclosure. In many embodiments, the subject stationary phases are employed in liquid chromatography (“LC”) protocols, e.g., high performance liquid chromatography (“HPLC”) protocols, e.g., reversed phase high performance liquid chromatography (“RP-HPLC).

The subject compositions may be employed to separate a variety of organic and inorganic constituents or analytes as will be apparent to those of skill in the art. That is, a wide variety of constituents may be separated according to the subject invention, where the subject stationary phases may be employed to separate non-polar, polar, e.g., highly polar, and ionic constituents, sometimes in the same separation process. The constituents may be naturally occurring or synthetic, and may be pre-processed or otherwise manipulated prior to separation by the subject invention. Representative constituents include, but are not limited to, proteins, peptides, polypeptides, glycoproteins, saccharides (mono- poly- and oligo-saccharides) nucleic acids, lipids, phospholipids, fullerene compounds, glycolipids, carboxylic acids, vitamins, catecholamines, purines, pyrimidines, nucleotides, various polar pharmaceuticals, organic compounds, etc. In certain embodiments, a constituent may be derivatized such that an easily detectable chemical group may be attached to the constituent, e.g., to make the constituent easy to detect once it emerges from the stationary phase. Examples of such derivatization processes include attaching an ultraviolet absorbing group to a constituent, attaching a fluorescent group to a constituent, attaching an electrochemical group to a constituent, etc.

As noted above, a feature of the subject invention is the use of a stationary phase that, when used with a mobile phase to separate constituents under suitable conditions, is resistant to hydrolysis by the mobile phase during use, (i.e., the bonded phase of the stationary phase is resistant to hydrolysis), especially when used with a mobile phase having a low to medium pH. By “stationary phase” is meant the immobile phase involved in the separation process, e.g., a chromatographic process. The stationary phase of the subject invention includes a substrate (i.e., a solid support) and a bonded phase, where the bonded phase is attached, associated, connected or otherwise coupled or linked to the substrate. The immobile phase may be contrasted with the mobile phase or eluent, as will be described in greater detail below. The stationary phase employed in the subject invention may be, e.g., a solid, a bonded or coated phase on a solid support, or a wall-coated phase. Typically, the stationary phase is made up of a plurality of particles, e.g., as is known in the art for HPLC protocols.

A variety of materials may be employed for the substrate of the stationary phase, where suitable materials include, but are not limited to, silica (e.g., SiO₂), alumina (e.g., Al₂O₃), TiO₂, ZrO₂), and other suitable metal or transition metal oxides particles, polymeric materials such as poly styrene-divinylbenzene (PS-DVB), organo modified metals or transition metal oxide particles (hybrid) and continuous metal oxides or chemically modified metal oxide monolithic structures. Of interest is the use of silica, e.g., silica gel particles, for use with the subject invention, particularly spherical silica, however irregular particles may be employed as well in certain embodiments.

The substrate has a pore size that facilitates constituent separation such that it allows free diffusion of the constituents to be separated into and out of the pores so that the constituents can interact with the bonded phase. Accordingly, the substrate may have an average pore size that ranges from about 30 Å to about 1000 Å such that there may be a wide range of pore size distribution of a given substrate, as determined by, e.g., the method of Halasz (Ber. Bunsenges Phys. Chem. (1975) 79, 731) as modified by Bidlingmeyer (Anal. Chem. (1984) 56, 950) or by mercury intrusion and gas condensation/evaporation, as known in the art. However, average pore sizes greater than about 1000 Å or less than about 30 Å may also be employed in the subject invention in certain embodiments.

In many embodiments, all of the particles making up a given stationary phase have the same or substantially the same average pore size. However, in certain embodiments some of the particles may have average pore sizes that differ from other particles such that a stationary phase may have a mix or range of pore sizes. For example, the particles of different pore sizes may be mixed together, e.g., randomly, or they may be provided in a particular form or pattern, e.g., a gradient of pore sizes may be employed. In such a pore size gradient, the mobile phase is contacted with a plurality of particles that provide a gradient of pore sizes for example from largest to smallest pore sizes or vice versa. That is, in such a gradient the pore sizes of the substrate of the stationary phase contacted first by the mobile phase are greater (or less than), i.e., are different from, the pore sizes that are contacted at a later point in time by the mobile phase.

The total porosity of the substrate is chosen to optimize the particular separation procedure being performed. Accordingly, the porosity of the substrate of the subject invention, i.e., the total porosity of a substrate or given particle thereof, or the volume that is porous/total volume of the particle, e.g., of each particle that makes up a given stationary phase, may vary depending on the particular separation protocol being performed. In certain embodiments, the specific surface area of a given particle, e.g., of each particle that makes up a given stationary phase, may range from about 1 cm²/gram to about 800 cm²/gram, e.g., from about 15 cm²/gram to about 500 cm²/gram. In certain embodiments, the total porosity may vary within a given stationary phase. For example, a stationary phase may include a plurality of particles having various degrees of porosity such that a mixture of particles differing at least in total porosity may be employed.

The size of the substrate that makes up the stationary phase is selected depending on the particular separation process. In certain embodiments, the substrate is relatively small and in certain other embodiments the substrate is relatively large. The size of a given substrate, e.g., the size of each particle of the stationary phase, may range from about 1 μm to about 300 μm or more, usually from about 1 μm to about 200 μm, where in certain embodiments particles of various sizes may be employed. When present in a chromatography column such as an RP-HPLC column, the size of a given chromatography column selected for use with the subject invention may dictate the size of the stationary phase and/or the total number of stationary phase particles to be packed therein. RP-HPLC columns of various lengths may be used. For example, in small scale operations, columns having dimensions as small as about 0.1 mm×about 10 mm may be used or in large scale operations columns having dimensions as large as about 500 mm×about 3000 mm may be used. These column dimensions are exemplary only and are in no way intended to limit the scope of the invention.

As noted above, the stationary phase includes a bonded phase such that at least one bonded phase is bonded to the substrate of the stationary phase. For example, one or more bonded phases may be bonded to the substrate, e.g., in those embodiments having substrate of a plurality of particles, at least one particle has at least one bonded phase, and typically all or substantially all of the particles have at least one bonded phase. The bonded phase is typically chemically bonded to the substrate of the stationary phase, e.g., covalently bonded such as covalently bonded to an oxygen atom of the stationary phase surface. Typically, a majority of the bonded phase is positioned within the pores of the substrate, however a portion of the bonded phase may be positioned on the outside of the pores or rather the outer surface of the substrate, e.g., the outer surface of silica particles.

The bonding density, i.e., the amount of surface area of the substrate (a particle of the stationary phase) covered by the bonded phase, may vary depending on the size of the substrate, the pore size, etc., where in certain embodiments the bonding density may range from about 0.5 μmol/m² to about 6 μmol/m² usually from about 1 μmol/m² to about 4 μmol/m² and more usually from about 2 μmol/m² to about 3 μmol/m², as determined by, e.g., the method described in G. E. Beredensen and L. de Galan, J. Liq. Chromatogr., 1, 561(1978).

As described above, the stationary phases of the subject invention include a bonded phase made up of a silicon atom that is directly attached to the substrate at one or a first position and also directly attached to a bulky group at another or second position and directly attached to a long chain moiety having an embedded polar group at another or third position. That is, both a bulky group and an embedded polar group-containing long chain are directly attached to the silicon atom at different positions on the silicon atom. By directly attached it is meant that there are no intervening groups or atoms between the bulky group and the silicon atom or the long chain and the silicon atom (in certain embodiments the embedded polar group of the long chain may be directly positioned adjacent the silicon atom where such is not to be construed as an indirect attachment of the long chain to the silicon atom). Accordingly, neither the bulky group nor the long chain is indirectly attached to the silicon atom. In certain embodiment, the silicon atom is directly attached to two bulky groups positioned at two different locations on the silicon atom. For example, in certain embodiments, the bonded phase is made up of a silicon atom that is directly attached to the substrate at one or a first position, directly attached to a bulky group at another (different) or second position, directly attached to a bulky group at yet another (different) or third position (where the two bulky groups may be the same or different) and directly attached to a long chain moiety having an embedded polar group at yet another (different) or fourth position. In certain other embodiments, the bonded phase is made up of a silicon atom that is directly attached to the substrate at one or a first position, directly attached to a bulky group at another (different) or second position, directly attached to a methyl group at yet another (different) or third position and directly attached to a long chain moiety having an embedded polar group at yet another (different) or fourth position.

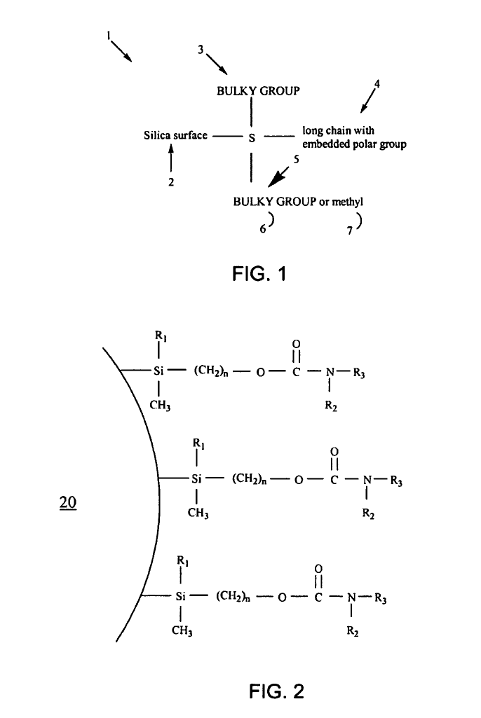

FIG. 1 shows a generalized schematic illustration of an exemplary embodiment of a stationary phase 1 in accordance with the subject invention. As shown in FIG. 1, the substrate 2 is represented by silica, but as described herein the substrate may be made of other materials in certain embodiments. Stationary phase 1 includes a bulky group 3 and a long chain with an embedded polar group 4 directly attached to the silicon atom. As shown, the silicon atom may also be directly attached to a second bulky group 6 (which may be the same or a different bulky group from bulky group 3) or methyl 7. As such, in certain embodiments a single (i.e., just one) bulky group is employed and in certain other embodiments two bulky groups are employed. For example, employing one bulky group will result in a higher carbon load than using two bulky groups. Employing two bulky groups may result in increased stability.

Accordingly, the inventors of the subject invention have discovered that embodiments of the subject bonded phases of the subject invention may provide, among other features, good: resistance to hydrolysis and enhanced stability, as compared to bonded phases known in the art, e.g., alkyl chain phases alone such as C8 and C18 or even alkyl chain phases that include other types of groups such as non-bulky groups such as ethyl and methyl similarly positioned on a bonded phase. For example, embodiments of the subject stationary phases as are herein described may provide good resistance to hydrolysis of the bonded phase while conventional stationary phases, including bonded phases as noted above that include other types of groups such as non-bulky groups such as ethyl and methyl similarly positioned on a bonded phase (i.e., do not include any bulky groups), do not provide the same beneficial results as embodiments of the subject stationary phases. Furthermore, the inventors of the subject invention have also discovered that embodiments of the subject bonded phases may provide good, including alternative, selectivity and retention to that achievable from conventional bonded phases. Still further, embodiments of the subject bonded phases may also provide good peak shape of acidic and basic constituents over conventional bonded phases.

Accordingly, a feature of the subject stationary phase is the inclusion of at least one bulky group directly attached to the silicon atom, i.e., a bulky side group. By “bulky group” it is meant a group having greater than two carbon atoms and having at least one branch within two carbon atoms from the silicon atom to which it is attached. For example, a bulky group of the subject invention may include from about 3 to about 6 carbon atoms, such as, but not limited to isopropyl, sec-butyl, tert-butyl, isopentyl, sec-pentyl, isohexyl. Accordingly, groups having less than two carbon atoms, e.g., methyl or ethyl groups, are not bulky groups according to the subject invention. The bulky group of the bonded phase provides resistance, in certain embodiments complete resistance, to hydrolysis of the bonded phase. As described above, in many separation protocols employing a stationary phase having a bonded phase attached to a substrate, the bonded phase is prone to hydrolysis by the mobile phase employed in the separation protocol. This is particularly problematic when the particular mobile phase has low to medium pH.

The long chain having the embedded bonded phase may be any suitable organic moiety. By “long chain” it is meant a chain having at least about 6 atoms forming a chain, such as about 6 to about 30 atoms, e.g., from about 10 to about 20 atoms. In many embodiments the long chain is a hydrocarbon chain and, as such, has a number of carbon atoms in the range described above. For example, as will be described below, in many embodiments the long chain is a hydrocarbon chain having a number of carbon atoms that falls within the ranges described above and which also contains heterofunctionality such as carbonate, carbamate, urea, ether, amide, and the like. For example, in certain embodiments that include two bulky groups, each directly attached to the silicon atom at two different positions, the long chain attached to the silicon atom may include an embedded carbonate, carbamate, urea, ether or amide group. Regardless of the type of long chain, a given long chain is selected to achieve optimum separation of the constituents of interest. In certain embodiments a mixture of different lengths of chains, e.g., different lengths of alkyl groups, may be employed for a given stationary phase, e.g., a given particle may have chains of various lengths and/or various particles of a plurality of particles making up a given stationary phase employed in a separation protocol may have different chain lengths.

The long chain, e.g., a long hydrocarbon chain, includes an embedded polar group, e.g., an embedded polar functional group. Such an embedded polar group renders the stationary phase more polar than would be without the embedded polar group. The embedded polar group may be any suitable polar group, where polar groups may include, but are not limited to carbonate, carbamate, urea, ether, amide, and the like. The embedded polar group may be positioned in any suitable position of the long chain such that it may be positioned at an end of the chain and therefore may be a terminally embedded polar group or may be positioned within the long chain, i.e., positioned between any two atoms of the chain.

In many embodiments, the bonded phase may be described by the formula:

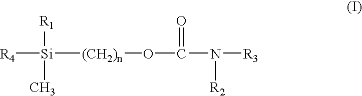

Where:
“n” (i.e., “n” in regards to (CH₂)ₙ) is an integer ranging from about 2 to about 6,
“R₁” is a bulky group,
“R₂” is hydrogen or an alkyl group,
“R₃” may have the formula CₓH₂ₓ₊₁ wherein “x” is an integer ranging from about 6 to about 25, or “R₃” may have the formula CH₂CH₂CₙF₂ₙ₊₁, and “n” is an integer ranging from about 2 to about 10, and
“R₄” is chosen from methoxy, ethoxy, halogen and substituted amino groups (e.g., mono and di substituted amino groups).

As shown, the silicon atom may be attached to the bonded phase at the open or free position (see below which shows this compound attached to a silica stationary phase).

The subject bonded phase may be prepared according to any convenient protocol. In general, in preparing a stationary phase according to the subject invention, a bonded phase is prepared and then chemically, e.g., covalently attached, to the stationary phase, as shown in FIG. 1.

In one exemplary embodiment, in preparing a subject stationary phase, an organosilane phase may be prepared, and which may be employed to prepare a bonded phase, which may be described by the formula:

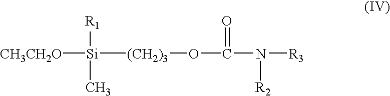

This compound as described by formula IV may be directly attached to a substrate, where such may be accomplished in a one step reaction process in many embodiments (as noted above in certain embodiments the silicon atom includes two bulky groups (the same or different) instead of just one bulky group and CH₃). In the compound described by this particular formula (formula IV), the embedded polar group is carbamate, but other polar groups may be employed as well as described above and may be positioned elsewhere in the long chain. In the compound described by formula IV, “R₁” is a bulky group, “R₂” is hydrogen or an alkyl group, “R₃” has the formula CₓH₂ₓ₊₁ wherein “x” is an integer ranging from about 6 to about 32, and “n” is an integer ranging from about 2 to about 6 or “R₃” may have the formula CH₂CH₂CₙF₂ₙ₊₁, and “n” is an integer ranging from about 2 to about 10.

Compound IV may then be attached to the substrate, e.g., silica particle, and the like, to provide a stationary phase having a silicon atom attached thereto, wherein the silicon atom is directly attached to a bulky group and a long chain having an embedded polar group. Compound IV may be prepared using any suitable techniques in the art. An exemplary protocol for preparing the subject stationary phases using the compound of formula IV is provided below and described with respect to the preparation of compounds II, IIA, IIIB and IV.

Prepare Silicon Atom: 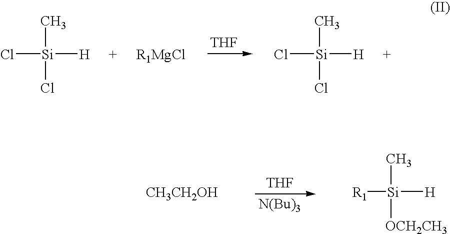
Where “R₁” is a bulky group (e.g., isopropyl, isobutyl, isopentyl, etc.)

Prepare Long Chain Having Embedded Polar Group (Herein Represented as Carbamate):

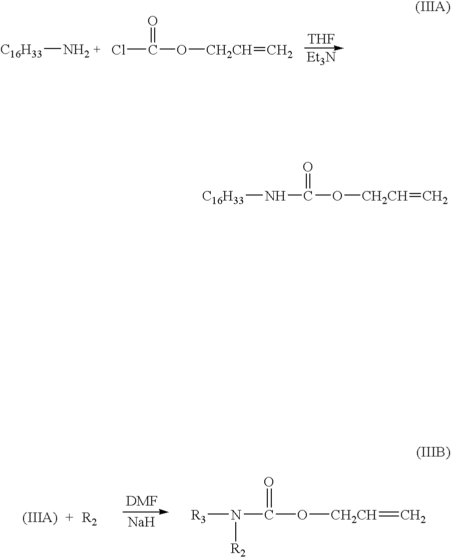

Where:
“R₂” may be a hydrogen or an alkyl group, and
“R₃” may have the formula CₓH₂ₓ₊₁ wherein “x” is an integer ranging from about 6 to about 25, or “R₃” may have the formula CH₂CH₂CₙF₂ₙ₊₁, and “n” is an integer ranging from about 2 to about 10.

Attach Long Chain Having Embedded Polar Group to Silicon Atom Using Compounds II and IIIB:

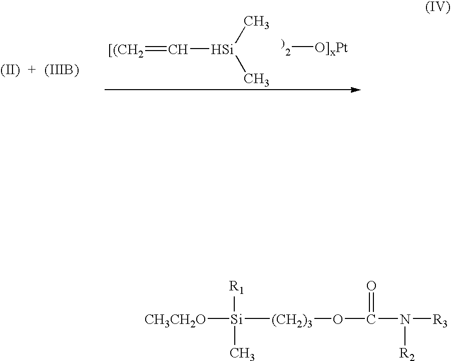

Where “x” is a catalyst such as platinum divinyl complex, 2-3% platinum concentration in xylene, neutral (e.g., available commercially from UCT, Inc.)

Attach Bonded Phase (Compound IV) to a Silica Surface:

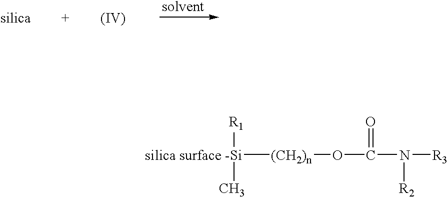

Other bonded phases may also be employed, as noted above. For example, to prepare a carbonate bonded phase, to make a carbonate bonded phase (replace N—R₂ with O in formula IV), R₃NH₂ may be replaced in formula IIIA with R₃OH to provide a carbonate instead of a carbamate. The subsequent hydrosilylation and bonding reaction are analogous to the preparation of a carbamate phase. To prepare a urea bonded phase, allylchloroformate may be replaced with allyisocyanate in formula IIIA to make a urea. The subsequent hydrosilylation and bonding reaction are analogous to the preparation of a carbamate phase. To prepare an amide bonded phase both the R₃NH₂ and the allylchloroformate may be replaced in formula IIIA with R₃COCl and allylamine. The subsequent hydrosilylation and bonding reaction are analogous to the preparation of a carbamate phase. To prepare an ether phase, both the R₃NH₂ and the allylchloroformate may be replaced in formula IIIA with R₃Br and allyl alcohol. To make the ether phase, both the R₃NH₂ and the allylchloroformate in (IIIA) may need to be replaced with R₃Br and allyl alcohol. The following hydrosilylation and bonding reaction are similar to making carbamate phase.

As described above, typically a plurality of bonded phases are attached to a substrate to provide densities as described above, as shown in FIG. 2 which shows substrate 20 having a plurality of bonded phases. As noted above, most of the bonded phase is present inside the pores of the substrate. Regardless of the particular bonded phase that is bonded to the stationary phase, once bonded any remaining functional groups or moieties, e.g., residual silanol groups, present on the stationary phase may be endcapped. A stationary phase is said to be “endcapped” when residual moieties or groups such as residual silanols, on a stationary phase surface, present after the bonding of the bonded phase to the stationary phase, are further reacted with a second agent, e.g., a silyating agent, to bond or cap as many of these residual moieties (e.g., residual silanols) as possible. For example, in the case of a silica stationary phase, endcapping of residual silanols may be accomplished with a small, reactive silane such as trimethylchlorosilane or the like to produce an endcapped stationary phase. Such endcapping protocols, e.g., employing small silylating agents (e.g., trimethylchlorosilane), for performing endcapping are well known in the art and thus are not described in detail herein.

Systems

Also provided are systems for separating at least two constituents using the subject stationary phases. As noted above, in certain embodiments the stationary phases of the subject invention are employed in HPLC protocols, e.g., RP-HPLC. As such, in accordance with the subject invention, systems that use the subject stationary phases in HPLC protocols are provided. In general, the subject systems include (1) a stationary phase as described above, i.e., a stationary phase that includes at least one bonded phase, where the bonded phase includes a silicon atom directly attached to At least one bulky group, and an embedded polar group-containing carbon chain, (2) an aqueous fluid (i.e., a mobile phase) having at least two constituents, and (3) an apparatus configured to perform an HPLC protocol. The subject system typically also includes a fluid delivery system, a sample injection system, e.g., a sample injection valve, a separation column, and a detector, where some or part of the system may be automated.

FIG. 2 shows an exemplary embodiment of a system 10 according to the subject invention, where the system is configure to be utilized in an HPLC protocol, e.g., a RP-HPLC protocol. As shown in FIG. 2, system 10 includes a variety of components, where some of the components may be optional (e.g., a guard column, additional reservoirs, etc.).

As shown, system 10 includes at least one fluid reservoir 12 for containing a fluid, e.g., a mobile phase or eluent. The mobile phase may be a single fluid or more than one fluid such that if more than one fluid is employed, the fluids may be used in a separation protocol simultaneously or sequentially, e.g., a gradient separation process and the like. Mobile phases include aqueous and non-aqueous fluids and organic and inorganic fluids. For example, fluids include, but are not limited to water (pure water such as deionized water, distilled water, and the like), organic solvents, e.g., acetonitrile, methanol, propanol, ethanol, isopropanol, and the like, etc.

The pH of the mobile phase may vary depending on the particular separation protocol and as such may range from low pH to high pH, i.e., may range from pH 1-14 such that the pH may range from highly acidic to highly basic. As described above, in certain prior art separation protocols, for example when the mobile phase has a low to medium pH, the bonded phase may be hydrolyzed. However, in accordance with the subject invention, the bonded phase is well resistant to such hydrolysis. The fluids of the subject invention may include a suitable buffering system, as noted above, to maintain a suitable pH over the course of a separation protocol.

Usually, the mobile phase is degassed to eliminate dissolved gas from the mobile phase fluid prior to use (and/or during use) in a separation protocol. Such degassing may be performed by heating or by vacuum (e.g., in a vacuum flask), or in-line using evacuation of a tube made from gas permeable substances such as PTFE, or by helium sparging.

In many embodiments more than one fluid may be employed in a given separation protocol (e.g., in parallel or simultaneously or in succession). For example, an isocratic elution may be employed such that the eluent is not changed during a separation run such that only one fluid is employed. In other embodiments, a gradient (continuous, gradual or step) elution is employed such that two or more elution compositions are employed. For example, a first fluid may be employed having a particular concentration and at least a second fluid may also be employed, where the second fluid may differ from the first fluid in one or more respects and may be employed at the same time, before or after the first fluid. For example, the second fluid may include the same components as the first fluid, e.g., water and acetonitrile or the like, but in different proportions than the first fluid and/or at different pH, etc., or in certain instances the second fluid may include different components from the first fluid or at least one or more different components. In such a manner, a steady change of eluent strength may be employed for a separation, e.g., one or more successive eluents may have increasing strengths such that they may include water and increasing amounts of a less polar solvent, and the like.

In certain embodiments, only one reservoir is provided that includes the mobile phase to be used. In certain embodiments, additional reservoirs are provided such as optional reservoir 13, where such may include a different mobile phase, e.g., a second mobile phase, or different proportions of a mobile phase, or may include an additive or modifier to be added to the aqueous component contained in reservoir 12. In this manner, the proportion of the components of the mobile phase may be altered, e.g., gradually or step-wise, during a given protocol by adjusting the amount of fluid allowed to flow from a given reservoir. In use, the fluids contained in the reservoirs may be combined in a particular proportion to be used throughout the entire separation process or may be combined in various proportions, where the proportion may vary at different times throughout the separation process. The constituents of interest, i.e. to be separated, may be added to the reservoirs, but are typically combined with the mobile phase at a later, downstream location (see sample introduction syringe or valve 24). Regardless of the number of reservoirs employed, typically each is coupled to an outgassing element 8 and 9 for degassing the fluid contained in the reservoir. An optional mixing vessel 15 may be included when two or more reservoirs are employed to ensure complete mixing of the components of the mobile phase.

Fluid from the reservoir(s) are typically passed through a suitable filter element 14 (and optional additional filter 7) to eliminate or substantially reduce any contaminants or elements that may be deleterious to the column or the constituents of interest. Fluid is then pumped, via pump 16, through a pressure relief and vent and a pressure gauge 20 is typically employed at a suitable location in-line, usually prior to fluid entering the separation column 28 and may also be prior to entering optional guard column 22. Pump 16 may be any suitable pump such as a reciprocating piston pumps, a syringe type pump, a constant pressure pump, etc. Usually, pump 16 provides a steady high pressure with no pulsations and may be programmed to vary the composition of the mobile phase during the course of the separation.

In many embodiments, a small “guard” column 22 may be positioned before or after the sample injection port 26, but before the analytical or separation column 28. This optional guard column 22 protects the separation column 28 against components in the mobile phase that may be harmful to the system and/or the separation process such as components that may clog the separation column 26, compounds and ions that may cause “baseline drift”, decreased resolution, decreased sensitivity, and create false peaks, compounds that may cause precipitation upon contact with the stationary or mobile phase, and compounds that might co-elute and cause extraneous peaks and interfere with detection and/or quantification. Guard column 22 may be packed with the same stationary phase as separation column 28 and may be of the same inner diameter as column 28, but may be packed with a different stationary phase than separation column 28 and/or have different dimensions, e.g., a shorter length.

A temperature-regulating element 23 for use in regulating the temperature of the separation process may be coupled with the system, herein shown positioned prior to sample introduction element 26, but may be positioned in any convenient location.

Samples are typically injected into the system via an injection port 26. The injection port usually, though not always, includes an injection valve and a sample loop (not shown). The sample is drawn into a syringe 24 and injected into the loop via the injection valve. A rotation of the valve rotor closes the valve and opens the loop in order to inject the sample into the stream of the mobile phase. Loop volumes can range between about 10 μl to over about 500 μl. As noted above, in certain embodiments a sample may be added to the mobile phase at an earlier location in the system, e.g., to one or more reservoirs. In many systems, sample injection may be automated.

As shown, separation column 28 includes the stationary phase 27 of the subject invention. Separation column 28 may be fabricated from any suitable material such as glass, stainless steel or plastic. The dimensions of column 28 may vary depending on a variety of factors relating to a particular separation process, e.g., the constituents of interest, the stationary phase, the mobile phase, etc. For example, a column may have a length that ranges from about 5 mm to about 3000 cm, usually from about 10 mm to about 300 mm and more usually from about 50 mm to about 300 mm, and an internal diameter or width that ranges from about 0.01 mm to about 250 cm or more, usually from about 0.1 mm to about 8 mm and more usually from about 0.1 mm to about 4.6 mm Of course, columns having dimensions other than those described above may also be employed. In many embodiments, the total volume of mobile phase in a given column or void volume or interstitial volume (the remainder of the column is taken up by the stationary phase) may range from about 1% to about 70% of the total volume of an empty column, wherein certain embodiments it maybe about 50% of the total volume of an empty column. The separation column usually, though not necessarily, includes end fittings (not shown) at one or both ends of the column that connects the column to the sample injector and/or detector. Oftentimes such endfittings include a frit to hold or contain the stationary phase in a suitable packing configuration (e.g., a dense packing configuration), where such frits may be made from any suitable porous material such as stainless steel or other inert metal or plastic such as PTFE or polypropylene.

System 10 also includes a suitable detector 29 for detecting constituents of the eluant as the eluant exits column 28. As noted above, suitable detectors include mass spectrometers, UV-VIS detectors, refractive index detectors, fluorescent detectors, electrochemical detectors, etc. In many embodiments detector 29 is operatively associated with an amplifier 30 for amplifying the signal produced by the detector and also to a user interface or readout 32 for communicating or displaying the results of the detector to a user. The system may be operatively coupled to a data collection unit such as a computer 34 which may be integrated with one or more components of the system, i.e., a unitary piece of construction, or may be a separate component.

Methods

Also provided are methods for separating at least two constituents. The subject methods are characterized by employing a stationary phase of the subject invention. In many embodiments, the subject methods are methods of performing a HPLC protocol, e.g., RP-HPLC. As such, a given stationary phase of the subject invention may be present in a suitable HPLC column or tube. In practicing the subject methods, at least one mobile phase having at least two constituents is contacted with a subject stationary phase to separate the constituents.

Prior to being contacted with the stationary phase, the constituents of interest, i.e., the constituents to be separated, are added to or otherwise combined with aqueous fluid(s) or mobile phase(s), where the constituents may be processed prior to such combining. As mentioned, embodiments of the subject invention may provide good resistance, oftentimes complete resistance, to hydrolysis by the mobile phase and good selectivity and retention, e.g., as compared to prior art methods of separating constituents, e.g., methods that employ simple alkyl bonded phases or even alkyl bonded phases that have embedded polar groups with or without non-bulk groups.

As noted above, one or more fluids may be employed, e.g., fluids of one or more different components or different proportions of the same components, different pH, etc. The constituents may be included in a sample, where the term “sample” as used herein relates to a material or mixture of materials, typically, although not necessarily, in fluid form, containing one or more constituents of interest. A sample may be any suitable sample that includes at least two constituents, where the sample and/or the constituents may be natural or synthetic and may be pre-processed prior to separation, e.g., may be amplified, denatured, fractionated, etc. Representative samples may include, but are not limited to, biological fluids such as blood or blood derivatives or fractions, serum, urine, tears, etc., as well as non-biological fluids such as water, buffer and the like.

Once the constituents of interest are combined with the mobile phase, the constituent-containing mobile phase is contacted with the stationary phase under conditions sufficient to separate at least two constituents of the mobile phase. As noted above, embodiments of the subject invention may provide at least good resistance to hydrolysis and good selectivity and retention. By contacting the constituent-containing mobile phase with the subject stationary phase under conditions sufficient to separate at least two constituents of the mobile phase, the constituents are retained for a period of time by the bonded phase present in the pores of the stationary phase to separate them.

Accordingly, the elution order of the separated constituents is generally related to the various respective property or properties of the constituents, e.g., hydrophobicity, and the like, and how the respective property or properties relate to the characteristics of the stationary phase and the mobile phase such that the constituents that have the least amount of interaction with the stationary phase, or the most amount of interaction with the mobile phase, will exit the column first. For example, the elution order of sample constituents may be related to their hydrophobic properties such that the more hydrophilic the solute, the faster it will be eluted (i.e., the less is will be retained by the stationary phase) while the more hydrophobic it is, the slower it will be eluted (the more it will be retained by the stationary phase).

Typically, the constituent-containing mobile phase is flowed over or through the stationary phase at a flow rate that is suitable for the particular constituent separation, where the flow rate may range from about 0.001 μL/min to about 10,000 μL/min, usually from about 1 μL/min to about 10,000 μL/min and more usually from about 100 μL/min to about 5000 μL/min and the pressure under which the mobile phase is contacted with the stationary phase ranges from about 10 psi to about 60,000 psi or more, usually from about 100 psi to about 10,000 psi and more usually from about 1000 psi to about 6000 psi. The subject separation protocol is usually contacted with the stationary phase at temperatures that range from about 4° C. to about 95° C. and usually from about 25° C. to about 50° C.

The amount or volume (i.e., the elution volume or V_{R}) of the mobile phase required to elute a constituent from the stationary phase will vary depending on the particulars of the mobile phase, stationary phase and constituents to be eluted. For example, the elution volume may range from about 20 microliters to about 7,500 ml, e.g., from about 0.2 ml to about 60 ml, e.g., from about 0.2 ml to about 30 ml.

Once eluted, the eluate or effluent (i.e., the combination of the mobile phase and constituents exiting the stationary phase) is detected by a suitable detector, where a variety of detectors are known for such detection. Such detectors include ultraviolet (UV-VIS) detectors wherein the eluate is irradiated with a light source and the amount of light that passes from the light source, through the eluate and to the detector, is measured. Refractive index reflectors may also be employed wherein the detector measures the deflection of light by the eluate, where each constituent has a unique refraction index. Electrochemical detectors may also be employed in certain embodiments, wherein an electrochemical detector responds to analytes that can be oxidized or reduced at an electrode over which the eluate passes. In this manner, electric current through the electrode increases in proportion to the amount of constituent in the eluate. Also of interest are fluorescent detectors which respond to constituents in the eluate that fluoresce. In using such a fluorescent detector, the eluate is irradiated and the emission wavelengths are measured wherein the emission intensities are proportional to the amount of constituent in the eluate. Mass spectrometers may also be employed to detect and analyze separated constituents. Accordingly, the presence of constituents in the eluate may be recorded by mass spectroscopy, by detecting a change in UV-VIS absorption at a set wavelength, by refractive index, by fluorescence after excitation with a suitable wavelength, by electrochemical response, and the like. Regardless of the type of detector employed, typically the detector is coupled to a user interface or readout for communicating the results of the detection to a user. As described above, embodiments of the subject invention may not only provide good selectivity and retention, e.g., as compared with conventional bonded phases such as C8 or C18, but embodiments of the subject invention may also provide good peak shape of acidic and basic constituents due to the stationary phase.

A result from a method of the present invention may be a raw result, such as an analysis of the presence or amount of one or more components. The result may also be a processed result, such as a conclusion about a condition of a sample analyzed or the source from which it was obtained. For example, where the sample is from a biological source (such as an organism) the processed result may be a conclusion that the sample or source exhibits a particular condition (for example, the sample or source do or do not exhibit contamination, infection, or degenerative condition). A result from a method of the present invention (processed or not) may be forwarded (such as by communication) to a remote location if desired, for further use. When one item (e.g., a location) is indicated as being “remote” from another, this is referenced that the two items are at least in different buildings, and may be at least one mile, ten miles, or at least one hundred miles apart. “Communicating” information references transmitting the data representing that information as electrical signals over a suitable communication channel (for example, a private or public network). “Forwarding” an item refers to any means of getting that item from one location to the next, whether by physically transporting that item or otherwise (where that is possible) and includes, at least in the case of data, physically transporting a medium carrying the data or communicating the data.

Kits

Finally, kits for use in practicing the subject methods are provided. The subject kits include at least a subject stationary phase and instructions for using the stationary phase to separate at least two constituents. Specifically, the subject kits at least include a stationary phase that includes at least one bonded phase, where the bonded phase includes a silicon atom directly attached to (1) at least one bulky group, and (2) an embedded polar group-containing carbon chain, and instructions for using the stationary phase in the practice of the subject methods. The stationary phase included with the subject kits may be provided in a column or tube, e.g., for performing LC, (e.g., and LC column), e.g., HPLC, (e.g., an HPLC column), such that a given kit may include a column packed with the stationary phase of the subject invention.

The instructions that are provided with the subject kits are generally recorded on a suitable recording medium or substrate. For example, the instructions may be printed on a substrate, such as paper or plastic, etc. As such, the instructions may be present in the kits as a package insert, in the labeling of the container of the kit or components thereof (i.e., associated with the packaging or sub-packaging) etc. In other embodiments, the instructions are present as an electronic storage data file present on a suitable computer readable storage medium, e.g., CD-ROM, diskette, etc. In yet other embodiments, the actual instructions are not present in the kit, but means for obtaining the instructions from a remote source, e.g. via the internet, are provided. An example of this embodiment is a kit that includes a web address where the instructions can be viewed and/or from which the instructions can be downloaded. As with the instructions, this means for obtaining the instructions may be recorded on a suitable substrate.

The subject kits may also include at least some, if not all, of the components for separating at least two constituents. As such, the kits may include one or more containers such as vials or bottles, with each container containing a separate component for performing a protocol for separating at least two constituents. For example, a kit may include a prepared mobile phase or may include one or more components to prepare a mobile phase.

### EXPERIMENTAL

The following examples are put forth so as to provide those of ordinary skill in the art with a complete disclosure and description of how to make and use the present invention, and are not intended to limit the scope of what the inventors regard as their invention. Efforts have been made to ensure accuracy with respect to numbers used (e.g. amounts, temperature, etc.) but some experimental errors and deviations should be accounted for. Unless indicated otherwise, parts are parts by weight, molecular weight is weight average molecular weight, temperature is in degrees Centigrade, and pressure is at or near atmospheric.

Preparation of Allyl Carbamates:

(1a) O-allyl-N-hexadecylcarbamate

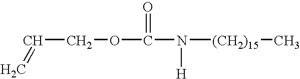

Into a 2-L flask was added 1-L THF, 100 g hexadecylamine and 57 mL of triethylamine. To the stirred mixture was added drop-wise 46 mL allylchloroformate which gave a turbid suspension and slight exotherm. The pot contents were stirred and filtered on sintered glass. The cake was washed free of salt and suspended in hexane. The residual water was extracted and the solid twice recrystalized from hexane. The white solid was filtered washed with hexane and dried in a vacuum desiccator overnight under P₂O₅. C, H, N elemental data and GC/MS analysis was consistent with the structure.

(1b) O-allyl-N-octadecylcarbamate

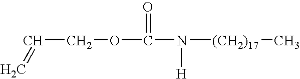

Into a 1-L flask was added 71 mL (10 mole excess) allyl alcohol and 0.4 mL imidazole. To the stirred mixture was added drop-wise 31 g octadecylisocyanate. The mixture was heated to 70° C. for 1-hr and was clear and colorless. The flask was stripped of excess allyl alcohol and short-path vacuum distilled and the fraction collected at 190° C./0.5 mm Hg. C, H, N elemental data and GC/MS analysis was consistent with the structure.

(2a) O-allyl-N-methyl-N-hexadecylcarbamate

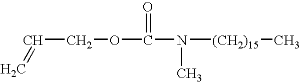

Into a 1-L flask was added 13.0 g O-allyl-N-hexadecylcarbamate (prepared in (1a) above) and 250 mL DMF. 1.09 g of 95% NaH was added and stirred for 1-hr. Diluted 2.55 mL of methyliodide in 20 mL DMF and added slowly drop-wise to the pot mixture. The mixture was stirred at room temperature overnight. Any remaining NaH was quenched with ethanol. Added 250 mL hexane and transferred to a 1-1 separatory funnel. The hexane was extracted with 3×150 mL DMF and water. The hexane layer was dried over MgSO4, filtered and stripped of hexane giving a clear yellow oil. C, H, N elemental data and FT-IR analysis was consistent with the structure.

Preparation of Silanes:

(3a) O-{3-(ethoxymethylisopropylsilyl)propyl}-N-methyl-N-hexadecylcarbamate

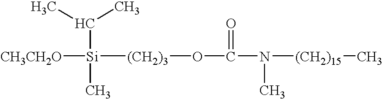

Into a 100 mL flask was added 1.61 g O-allyl-N-methyl-N-hexadecylcarbamate (prepared in (2a) above) and 150 uL vinyl Pt catalyst complex. The flask was heated to 60° C. and 1.5 g ethoxyisopropylmethylsilane was added. The pot mixture was heated to 110° C. and held for 1-hr and then stirred at 70° C. overnight. The turbid mixture was stripped of volatiles giving a slightly yellow turbid oil. C, H, N elemental data and FT-IR analysis was consistent with the structure.

(3b) O-{3-(chlorodiisopropylsilyl)propyl}-N-hexadecylcarbamate

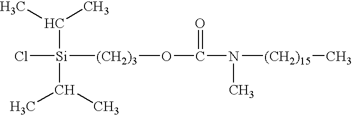

Into 25-mL flask was added 6.4 mL toluene, 1.04 mL chlorodiisopropylsilane, 1.07 g O-allyl-N-hexadecylcarbamate (prepared in (1a) above) and 0.1 mL vinyl Pt catalyst complex. The pot mixture was heated to 65° C. and held overnight. The flask was stripped of volatiles to a clear colorless oil and the structure was confirmed by GC/MS analysis.

(3c) O-{3-(chlorodiisopropylsilyl)propyl}-N-methyl-N-hexadecylcarbamate

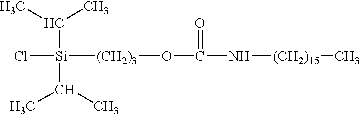

Into a 100 mL flask was added 4.84 g O-allyl-N-methyl-N-hexadecylcarbamate (prepared in (2a) above) and 250 uL vinyl Pt catalyst complex. The flask was heated from 70° C. to 130° C. while 3.05 ml chlorodiisopropylsilane was slowly added drop-wise. The pot mixture was held at 130° C. for 4-hr and then stirred at room temperature overnight. The semi-solid mixture was stirred briefly with hexane, stripped of volatiles and dried under a N2 atmosphere in a vacuum desiccator overnight. C, H, N elemental data and FT-IR analysis was consistent with the structure.

Preparation of Bonded Phases:

(4a) Bonding of EtOSi(iPr)Me(CH₂)₃OCON(Me)C₁₆H₃₃ onto the Silica Surface

To a 100 mL three-neck round bottom flask, 10 gram of 5 um Zorbax silica particle (80 Å average pore size, 180 m²/gram) was placed with 50 mL of toluene. Azetropic distillation was performed to remove water from the silica. After the mixture was cooled to room temperature, 10 gram of (3a) was added and the resulting mixture was refluxed for 16 hours. After the mixture was cooled down, it was filtered using a glass filter. The solid was washed with toluene (40 mL), THF (three times, 40 mL each), MeOH (three times, 40 mL each) and Acetonitrile (three times, 40 mL each), respectively, and subsequently dried in a vacuum oven for 4 hours at 100° C. The solid was then re-placed in the flask, and refluxed with 5 mL of N,N-dimethylamino trimethyl silane in 30 mL of toluene for 16 hours. The mixture was filtered when it was cooled to room temperature, washed with toluene, THF, MeOH and Acetonitrile respectively (the volume was similar as for the first wash). The solid was then dried in a vacuum oven for 4 hours at 100° C. The IR spectrum of the solid was in accordance with the proposed carbamate structure and C % was determined as 7.5%.

Making and Testing an HPLC Column:

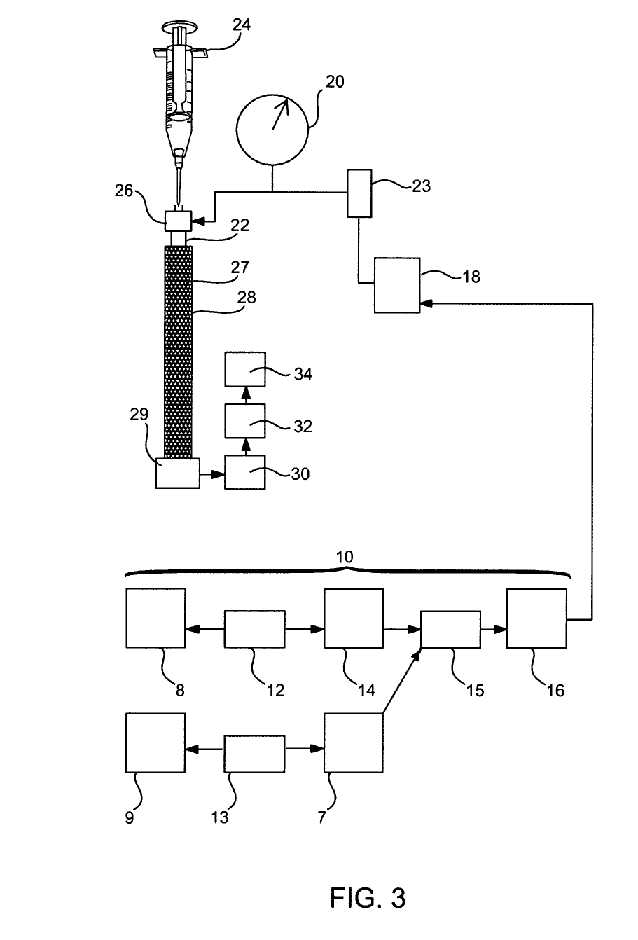

The particle obtained from (4a) was packed into a stainless steel tube of 4.6 mm internal diameter and 75 mm long using a slurry packing method. The column was run on an Agilent 1100 HPLC instrument (available from Agilent Technologies, Inc., Palo Alto, Calif.) equipped with having a DAD detector and the system configuration was analogous to the system of FIG. 3. The mobile phase was water and methanol. The column packed with the stationary phase of (4a) provided satisfactory separation results.

It is evident from the above results and discussion that the above described invention provides important new compositions and methods for separating at least two constituents of a mobile phase. Specifically, the subject invention provides stationary phases, systems and methods for separating constituents that may provide good: resistance to hydrolysis, selectivity, peak shape, ease of use and which may be cost effective. As such, the subject invention represents a significant contribution to the art.

All publications and patents cited in this specification are herein incorporated by reference as if each individual publication or patent were specifically and individually indicated to be incorporated by reference. The citation of any publication is for its disclosure prior to the filing date and should not be construed as an admission that the present invention is not entitled to antedate such publication by virtue of prior invention.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, process, process step or steps, to the objective, spirit and scope of the present invention. All such modifications are intended to be within the scope of the claims appended hereto.

1. A stationary phase for separating at least two constituents in a mobile phase, said stationary phase comprising at least one bonded phase comprising a silicon atom directly attached to a single bulky group and to a long chain comprising an embedded polar group.

2. The stationary phase of claim 1, wherein said bulky group comprises from about 3 to about 6 carbon atoms.

3. The stationary phase of claim 1, wherein said bulky group is an alkyl group.

4. The stationary phase of claim 3, wherein said bulky group is isopropyl or isobutyl.

5. The stationary phase of claim 1, wherein said stationary phase is chosen from silica, metals, metal oxides, modified metal oxides and polymers.

6. The stationary phase of claim 1, wherein said long chain comprises from about 6 to about 30 carbon atoms.

7. The stationary phase of claim 1, wherein said embedded polar group is chosen from carbonate, carbamate, urea, ether and amide.

8. The stationary phase of claim 1, wherein said stationary phase has the formula: 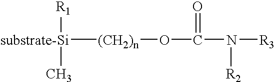
wherein:
“n” of (CH₂)ₙ is an integer ranging from about 2 to about 6;
R₁ is said bulky group;
R₂ is hydrogen or an alkyl group; and
R₃ has the formula CₓH₂ₓ₊₁ wherein x is an integer ranging from about 6 to about 25 or “R₃” has the formula CH₂CH₂CₙF₂ₙ₊₁, and “n” is an integer ranging from about 2 to about 10.

9. A stationary phase for separating at least two constituents in a mobile phase, said stationary phase comprising at least one bonded phase comprising a silicon atom directly attached to a bulky group and to a long chain comprising a carbonate, carbamate, urea or amide group.

10. The stationary phase of claim 9, wherein said bulky group comprises from about 3 to about 6 carbon atoms.

11. The stationary phase of claim 9, wherein said bulky group is an alkyl group.

12. The stationary phase of claim 11, wherein said bulky group is isopropyl or isobutyl.

13. The stationary phase of claim 9, wherein said silicon atom is directly attached to two bulky groups at two different positions.

14. The stationary phase of claim 9, wherein said stationary phase has the formula: 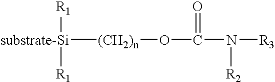
wherein:
“n” of (CH₂)ₙ is an integer ranging from about 2 to about 6;
R₁ is said bulky group;
R₂ is hydrogen or an alkyl group; and
R₃ has the formula CₓH₂ₓ₊₁ wherein x is an integer ranging from about 6 to about 25 or “R₃” has the formula CH₂CH₂CₙF₂ₙ₊₁, and “n” is an integer ranging from about 2 to about 10.

15. A liquid chromatography column comprising the stationary phase of claim 1.

16. A compound comprising a silicon atom covalently attached to a single bulky group and to a long chain comprising an embedded polar group.

17. The compound of claim 16, wherein said bulky group comprises from about 3 to about 6 carbon atoms.

18. The compound of claim 16, wherein said bulky group is isopropyl or isobutyl.

19. A compound comprising a silicon atom covalently attached to a bulky group and to a long chain comprising a carbonate, carbamate, urea, or amide group.

20. The compound of claim 19, wherein said silicon atom is directly attached to two bulky groups at two different positions.

21. The compound of claim 19, wherein said bulky group is isopropyl or isobutyl.

22. A method of separating at least two constituents of a mobile phase, said method comprising:
contacting said mobile phase with a stationary phase comprising at least one bonded phase comprising a single silicon atom directly attached to a single bulky group and to a long chain comprising an embedded polar group, under conditions sufficient to separate said at least two constituents.

23. The method of claim 22, wherein said embedded polar group is chosen from carbonate, carbamate, urea, ether and amide.

24. A method of separating at least two constituents of a mobile phase, said method comprising:
contacting said mobile phase with a stationary phase comprising at least one bonded phase comprising a silicon atom directly attached to a bulky group and to a long chain comprising a carbonate, carbamate, urea or amide group, under conditions sufficient to separate said at least two constituents.

25. The method of claim 24, wherein said silicon atom is directly attached to two bulky groups at two different positions.

26. A method comprising forwarding a result obtained by a method of claim 24 to a remote location.

27. A method according to claim 26, wherein said result is communicated.

28. A method comprising receiving a result obtained by a method of claim 24 from a remote location.

29. A system for separating at least two constituents of a mobile phase, said system comprising:
(a) a stationary phase comprising at least one bonded phase comprising a silicon atom directly attached to a single bulky group and to a long chain comprising an embedded polar group;
(b) a mobile phase comprising at least two constituents; and
(c) an apparatus configured to perform liquid chromatography.

30. The system of claim 29, wherein said bulky group is isopropyl or isobutyl.

31. A method of producing a stationary phase, said method comprising:
(a) preparing a bonded phase comprising a single silicon atom directly attached to a bulky group and to a long chain comprising an embedded polar group; and
(b) covalently attaching said bonded phase to a substrate to produce said stationary phase.

32. A method of producing a stationary phase, said method comprising:
(a) preparing a bonded phase comprising a silicon atom directly attached to a bulky group and to a long chain comprising a carbonate, carbamate, urea, or amide group; and
(b) covalently attaching said bonded phase to a substrate to produce said stationary phase.

33. A kit for separating at least two constituents of a mobile phase, said kit comprising:
(a) a stationary phase comprising at least one bonded phase comprising a silicon atom directly attached to a single bulky group and to a long chain comprising an embedded polar group; and
(b) instructions for using said stationary phase to separate at least two constituents of a mobile phase.
